(19) United States
(12) Patent Application Publication
(10) Pub. No.: US 2024/0201633 A1
(43) Pub. Date: Jun. 20, 2024

(54) METHOD FOR MANUFACTURING A TIMEPIECE COMPONENT

(71) Applicant: ROLEX SA, Geneva (CH)

(72) Inventors: Laurent Mincone, Jonzier-Epagny (FR); Olivier Greim, Yverdon-les-Bains (CH)

(73) Assignee: ROLEX SA, Geneva (CH)

(21) Appl. No.: 18/539,502

(22) Filed: Dec. 14, 2023

(30) Foreign Application Priority Data
Dec. 16, 2022 (EP) 22214339.8

(51) Int. Cl. G04D 3/00; B28B 1/24; B29C 45/00; B29C 45/32

(52) U.S. Cl. CPC G04D 3/0069; B28B 1/24; B29C 45/0053; B29C 45/32; G04D 3/0074; B29C 2059/027

(57) ABSTRACT

The method for manufacturing a timepiece component (10) having at least one first portion with at least one functional flank, for transmitting energy to another component or dissipating energy from another component, and at least one second portion with a guide surface,

includes carrying out a first micro-injection (E1) forming a blank (10′) of the timepiece component, the blank having the at least one first portion and the at least one functional flank and a blank of the second portion,
then a second machining (E2), particularly a second laser machining, in particular femtosecond laser machining, of at least part of the blank of the timepiece component, this part including the blank of the second portion for forming the second portion with the guide surface.

### CROSS-REFERENCE TO RELATED APPLICATION

This application claims priority of European patent application No. EP22214339.8 filed Dec. 16, 2022, the content of which is hereby incorporated by reference herein in its entirety.

### INTRODUCTION

The invention relates to a method for manufacturing a timepiece component comprising a functional portion for transmitting energy to another component of a timepiece movement or dissipating energy from another component of a timepiece movement, and a guide portion for guiding the movement of the timepiece component, in particular the rotation and/or translation thereof. The invention also relates to a timepiece component per se resulting from such a method, and a timepiece movement comprising such a timepiece component. Finally, the invention relates to a timepiece comprising such a timepiece component or such a timepiece movement.

### BACKGROUND ART

The machining of timepiece components made from technical ceramic as described for example in patent application EP3258325 is a difficult operation that requires complete control of the interactions between the tool and the material, so as not to create stresses or new defects in the ceramic, in particular surface defects, which would form incipient cracks detrimental in particular to the shock resistance of the components.

The manufacturing of small timepiece staffs, for example with a diameter of less than 2 mm, is particularly difficult, in particular in the presence of pivots with a very small diameter (<200 microns, or <100 microns) at the end of the staff, the function of which is to guide the staffs, particularly the pivoting thereof. These pivots must have a perfectly circular geometry, that is, they must form as perfect a surface of revolution as possible, and their dimensions must be highly accurate. They are designed to interact with a bearing, and any geometric defect such as out-of-roundness or an inaccurate diameter would result in impaired chronometric performance of the movement into which the staff was incorporated. The same applies if the surfaces of the pivots that interact with a bearing are excessively rough. This more particularly true for the balance staff.

This is why the staffs according to the prior art are turned from steel, and the pivots are then rolled to obtain the final roughness, hardness and shape.

In addition, the production of a functional portion around a timepiece staff, particularly the teeth of a pinion, likewise results in complexity, in particular due to the shape that the pinion is to adopt, particularly the geometry or specific orientation of the functional flanks of its teeth, for which an extremely precise geometry and a flawless surface finish must also be achieved, in particular very low roughness.

### SUMMARY OF THE INVENTION

Conventional machining techniques can be difficult to implement in order to obtain components with a complex shape, comprising not only a guide portion but also a functional portion. In particular, depending on the shape of the functional portion, particularly for example depending on the geometry or specific orientation of the functional flanks of the teeth of a pinion, the conventional machining techniques are inapplicable. In addition, these techniques are not suitable for all of the materials used for timepiece components. In particular, they are very difficult, or even impossible, to apply to ceramic parts, particularly because it takes a very long time to turn them using cutting tools or grinding wheels, and the tools wear rapidly.

Producing a timepiece component that comprises both a functional portion and a guide portion is therefore particularly complex, as the method must make it possible to achieve the specific geometric and mechanical requirements of said two portions. The surface roughness of said two portions must also be suitable for their respective functions. Such a method must also be as simple as possible so that it can be deployed on a large scale with a reasonable manufacturing time.

The aim of the invention is to provide a method for manufacturing a timepiece component that comprises both at least one functional portion and at least one guide portion.

A first object of the invention is to provide a method for manufacturing a timepiece component that comprises both a functional portion and a guide portion, that makes it possible to obtain a precise geometry and optimum roughness and mechanical properties of the timepiece component, in particular said two portions.

A second object of the invention is to provide the simplest possible method for manufacturing a timepiece component that comprises both a functional portion and a guide portion.

A third object of the invention is to provide a method for manufacturing a timepiece component that comprises both a functional portion and a guide portion, compatible with as many materials as possible.

To this end, the invention relates to a method for manufacturing a timepiece component, comprising at least one first portion comprising at least one functional flank, for transmitting energy to another component or dissipating energy from another component, and at least one second portion comprising a guide surface, characterized in that the method comprises:
a first micro-injection step forming a blank of the timepiece component, said blank comprising said at least one first portion and said at least one functional flank and comprising a blank of the second portion, then
a second machining step, particularly a second laser machining step, in particular femtosecond laser machining, of at least part of the blank of the timepiece component, this part comprising the blank of the second portion for forming the second portion comprising said guide surface. Said second machining step (E2) being implemented excluding said at least one first portion, which remains unchanged during this second machining step (E2).

The invention also relates to a timepiece component, comprising at least one first portion comprising at least one functional flank, for transmitting energy to another component or dissipating energy from another component, and at least one second portion comprising a guide surface, characterized in that the first and second portions of the timepiece component are integrally formed in one piece and in that said functional flank has a surface roughness Ra less than or equal to 50 nm, or less than or equal to 15 nm, or less than or equal to 12 nm, or less than or equal to 10 nm, and optionally greater than or equal to 5 nm.

The invention is more precisely defined in the claims.

### BRIEF DESCRIPTION OF THE DRAWINGS

These objects, features and advantages of the present invention will be disclosed in detail in the following non-limiting description of particular embodiments given with reference to the appended figures, in which:

FIG. 1 shows a first cross-sectional view of a mould for manufacturing a blank for a timepiece component according to one embodiment of the invention.

FIG. 2 shows an injection-moulded part resulting from the mould in FIG. 1 according to the embodiment of the invention.

FIG. 3 shows a blank for a timepiece component obtained by a first step of the manufacturing method according to one embodiment of the invention.

FIGS. 4 and 5 show the implementation of a second step of the manufacturing method according to the embodiment of the invention.

FIG. 6 shows an intermediate sub-step of the second step of the manufacturing method according to the embodiment of the invention.

FIG. 7 shows a sub-step at the end of the second step of the manufacturing method according to the embodiment of the invention.

FIG. 8 shows a simplified flow chart of the method for manufacturing a timepiece component according to the embodiment of the invention.

FIGS. 9 to 12 shows a first example of a timepiece component obtained by the manufacturing method according to the invention.

FIG. 13 shows a blank of a second example of a timepiece component obtained by a first step of the manufacturing method according to one embodiment of the invention.

FIG. 14 shows the second example of a timepiece component obtained by the method according to the invention.

### DETAILED DESCRIPTION OF PARTICULAR EMBODIMENTS

The concept of the invention consists of combining two very different manufacturing methods, injection moulding, in particular a ceramic injection moulding (CIM) or metal injection moulding (MIM) technique, and machining, to manufacture a timepiece component into two phases, respectively forming in their finished or near-finished form a first portion comprising at least one functional flank and a second portion comprising at least one guide surface.

A method for manufacturing a timepiece component according to one embodiment of the invention will now be described. In the embodiment described, the timepiece component according to this first exemplary embodiment is an escape-pinion.

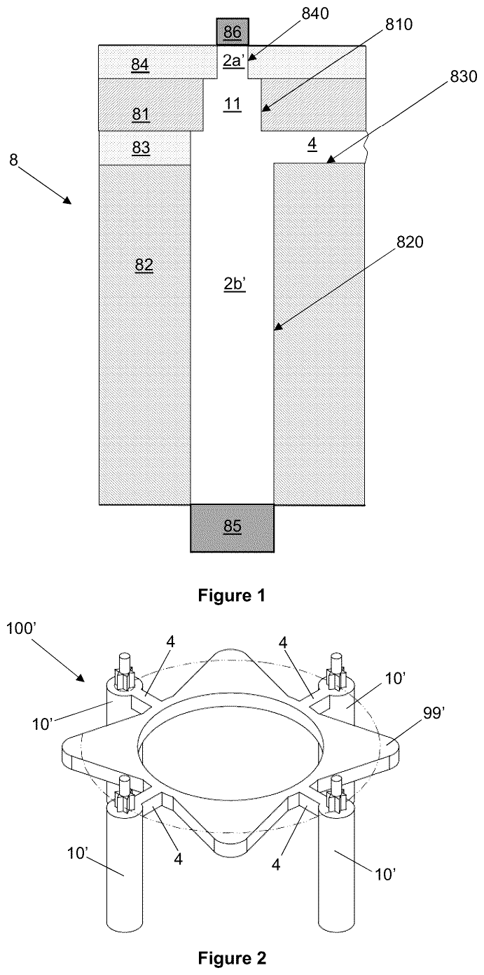

FIG. 1 shows a cross-sectional view of a core of an injection mould 8. According to this advantageous embodiment, this injection mould 8 is modular, and comprises an injection cavity formed by a plurality of removable intermediate plates, to provide flexibility when defining the geometry of this injection cavity. The injection mould 8 thus comprises in particular a first removable intermediate plate 81, interposed between a second removable plate 83 and a third removable plate 84, this assembly being associated with a first part 82, which can be fixed, of the injection mould. The injection cavity is thus defined by the conjunction of a plurality of cut-outs: a cut-out 820 in the first part 82, a cut-out 810 in the first plate 81, a cut-out 830 in the second plate 83, and a cut-out 840 in the third plate 84. The injection mould 8 also comprises ejector pins 85 and 86 positioned on either side of opposite openings of the injection cavity.

During the injection phase into such an injection mould 8, the material of the future timepiece component, which will be referred to as the component material, is injected into the injection cavity, in particular formed by the cut-outs 810, 820, 830, by means of the cut-out 830, this component material coming from the centre of the mould and forming a central injection sprue.

The component material that is injected can be a polymer, a metal, a composite, a cermet or a technical ceramic. Advantageously, the technical ceramic is mostly or mainly (by weight or mole) made up of zirconium oxide, and/or alumina. Zirconium oxide and/or alumina can thus be the predominant element(s) in the ceramic. Nonetheless, according to one variant embodiment, the proportion by weight or mole of zirconium oxide and/or alumina can be less than 50%.

In the case of a metal, the injection can comprise the injection of a molten metal or a metal in a vitreous state (namely at an injection temperature less than the melting temperature and greater than the glass transition temperature) into the injection mould. After cooling, it is possible to obtain for example a timepiece component blank made from an amorphous material, such as a metallic glass. In particular, the material of the blank can be any amorphous alloy the glass forming ability (GFA) of which makes it possible to obtain an amorphous structure in the typical dimensions of timepiece components, in particular an amorphous metal alloy comprising a metal base formed by at least one metal of the elements Ni, Cu, Pd, Pt, Fe, Co, Ti, Nb and Zr.

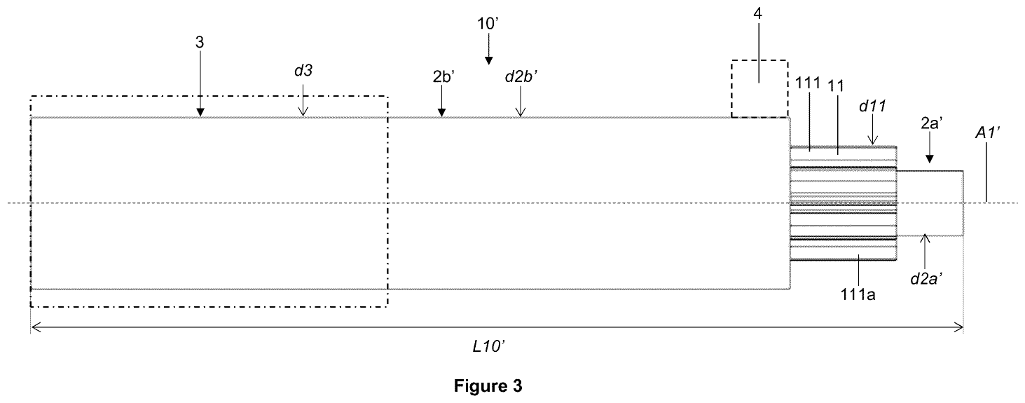

FIG. 2 shows an injection-moulded part 100′ obtained after its removal from the injection mould 8 described above. This injection-moulded part 100′ here comprises four identical timepiece blanks 10′ for a timepiece component, connected to each other by an injection layer, in particular by a central portion 99′ of said injection-moulded part 100′ and via supports 4, and a central injection sprue (not shown). After they have been separated, each blank 10′ has the form shown in FIG. 3, which will be described hereinafter.

Once this injection-moulded part 100′ has been consolidated, for example by cooling in the case of a metal or polymer injection-moulded part 100′ or by debinding and sintering in the case of a ceramic injection-moulded part 100′, the blanks 10′ are therefore removed from the part 100′ by separating them from the central portion 99′ by breaking the supports 4. To this end, the supports 4 can comprise mechanically weaker zones, such as notches, in order to promote the breaking thereof during this phase.

The sub-assembly of the injection mould 8 formed by the first part 82 and the plates 81, 83, 84 thus defines a cavity that makes it possible to form at least one blank 10′ during an injection moulding phase, which represents a first micro-injection step E1 of the method for manufacturing a timepiece component.

As mentioned above, this first step E1 advantageously uses a modular injection mould 8, that is, an injection mould 8 provided with at least one removable intermediate plate 81. Such an architecture can be as defined by the publication EP3981571. The architecture of such an injection mould allows the injection mould to be modified in a flexible manner simply by changing one or more intermediate plates, without having to manufacture the entire mould for each change. Thus, by way of example, the profile of the teeth 111 of the pinion 11 of the blank 10′, which will be described in detail hereinafter, can be modified simply by changing an intermediate plate. In addition, it is possible to form, for example, a stepped pinion that comprises superposed teeth with different tip-diameters. To this end, the pinion could in this case be the result of superposing intermediate plates comprising cut-outs forming injection cavities featuring the superposed teeth of the different steps of the pinion.

Advantageously, a removable plate 81 is produced using LIGA technology. This approach comprises, in a known manner, the formation of a mould by photolithography, and then the growth of a metal inside the mould. This LIGA technology is advantageous as it makes it possible to obtain a plate 81 with great precision, while making it possible to reproduce a plurality of identical intermediate plates using a single mask. Advantageously, due to LIGA technology, the cut-out 810 in the plate 81 can be intended to form a complex geometry of a blank 10′ for a timepiece component 10, for example the teeth 111 of a pinion, which cannot necessarily be achieved using conventional mechanical machining techniques. In addition, very advantageously, such a plate makes it possible to manufacture flanks 111a of a pinion 11 with low roughness. For example, such a plate, manufactured using LIGA technology from nickel Ni or nickel phosphorous NiP, makes it possible to obtain teeth 111 of a pinion 11 with flanks 111a having a roughness Ra (measured parallel or perpendicular to the axis A1′ of the blank 10′) that is particularly low, in particular of the order of 50 nm. As a variant, this roughness can be less than or equal to 50 nm, or less than or equal to 40 nm. It will be noted that laser machining such a flank would result in significantly greater roughness, at least of the order of 80 nm.

According to a particularly advantageous implementation of the manufacturing method, the first micro-injection step E1 can thus use an injection mould 8 comprising at least one intermediate plate 81, which can advantageously comprise nickel Ni or nickel phosphorous NiP and is provided with a cut-out 810 forming an injection cavity featuring teeth 111 of a pinion 11. More generally, the injection mould 8 comprises at least one intermediate plate 81, which can advantageously comprise nickel Ni or nickel phosphorous NiP and is provided with a cut-out 810 forming an injection cavity featuring at least or at least partially a functional flank of at least one first portion.

Furthermore, the different parts 81, 82, 83, 84 forming the injection mould are advantageously positioned with minimal clearance between them, for example by means of positioning pins. Also advantageously, the injection mould 8 makes it possible to form an injection-moulded part 100′ comprising a plurality of blanks 10′, so as to thus simultaneously manufacture a plurality of blanks 10′ for a timepiece component 10.

Naturally, the invention is not limited to the injection mould shown. Thus, as a variant, this mould could not comprise any removable plates, and the injection cavity could be obtained by any non-modular conventional mould architecture. Regardless of the variant, the injection cavity can advantageously be formed from an element or a plurality of elements the material of which is nickel Ni or nickel phosphorous NiP or comprising nickel Ni or nickel phosphorous NiP, particularly when step E1 implements a ceramic injection moulding (CIM) technique, namely when the component material injected is a technical ceramic. As a further variant, the injection cavity could define just one blank for a timepiece component.

According to the example shown, the first micro-injection step E1 of the manufacturing method therefore makes it possible to form a blank 10′ for a timepiece component. As shown in FIG. 3, this blank 10′ extends along an axis A1′. It is provided with a first portion comprising at least one functional flank 111a, a second portion 2a′, and a third portion 2b′, these second and third portions 2a′, 2b′ each comprising a surface of revolution, which here are positioned on either side of the first portion.

The first portion comprises a pinion 11 provided with teeth 111 forming functional flanks 111a. These functional flanks 111a of the teeth 111 have the function of transmitting torque to another timepiece component such as a wheel or a pinion.

The second portion 2a′ forms a right cylinder with a diameter d2a′ greater than the respective diameters d21a and d22a of the pivot 21a and the pivot shank 22a of the finished timepiece component, which will be described in detail hereinafter. This second portion 2a′ of the blank thus prefigures a portion 2a of the timepiece component. Advantageously, the diameter d2a′ is optimized with respect to the second step, which will be described hereinafter.

The third portion 2b′ also forms a right cylinder with a diameter d2b′, which has the specific feature of prefiguring both a portion 2b of the timepiece component to be manufactured, and an additional part that will be used as a grip part 3, as will be described in detail hereinafter.

In this exemplary embodiment, it therefore appears that the cut-out 820 in the first part 82 of the injection mould 8 forms a portion of the injection cavity featuring at least partially the third portion 2b′ of the blank 10′. In addition, the cut-out 840 in the third plate 84 forms a portion of the injection cavity featuring the second portion 2a′ of the blank 10′. Finally, the cut-out 830 in the second plate 83 forms a portion of the injection cavity featuring a support 4 formed on a central portion 99′ connecting different blanks 10′.

According to one embodiment of the invention, the method then implements a second step E2 of laser machining the blank 10′ resulting from the first step, in particular femtosecond laser machining. Generally, the aim of this second laser machining step E2 is finalize or nearly finalize the timepiece component 10 to be manufactured, particularly the geometry of the timepiece component 10 to be manufactured, by machining a part of the blank 10′ resulting from the first micro-injection step E1, to achieve a geometry and/or dimensions that correspond or substantially correspond to those of the final timepiece component 10 to be manufactured.

Advantageously, at least part of the blank 10′, in particular at least part of the first portion, is not machined, and comes out of this second laser machining step E2 unchanged. According to the exemplary embodiment, the pinion 11 obtained following the first step E1 is not machined during this second step. In other words, its final geometry is defined by the first step of the manufacturing method only.

Preferably, this second laser machining step E2 comprises a turning phase, that is, a machining step during which the component blank 10′ is rotated about an axis of rotation A9, and in which a laser beam can be moved with respect to this axis of rotation A9. Preferably, the laser scans the blank 10′ tangentially or at an angle of attack tangential to said blank 10′. Also preferably, the laser beam scans said blank 10′ along a helical trajectory. In any case, the laser does not strike the pinion 11, which therefore retains the geometry formed by the first micro-injection step.

To this end, this second step uses laser equipment 9 provided with a system for moving the blank 10′, particularly for rotating the blank 10′ about an axis A9, coincident with the axis A1′ of the blank 10′, which is also the axis of the future guide surface being manufactured. This laser equipment 9 comprises a spindle 91 rotating about the axis A9. Preferably, the spindle 91 can rotate at more than 200 rpm, or at more than 1′000 rpm, or at more than 20′000 rpm, or at more than 50′000 rpm, or at more than 100′000 rpm. In the exemplary embodiment described for obtaining an escape-pinion, the spindle 91 rotates at 2,000 rpm. For example, the spindle 91 is an electric spindle. Preferably, the spindle 91 is provided with a gripper 910, in particular pneumatic.

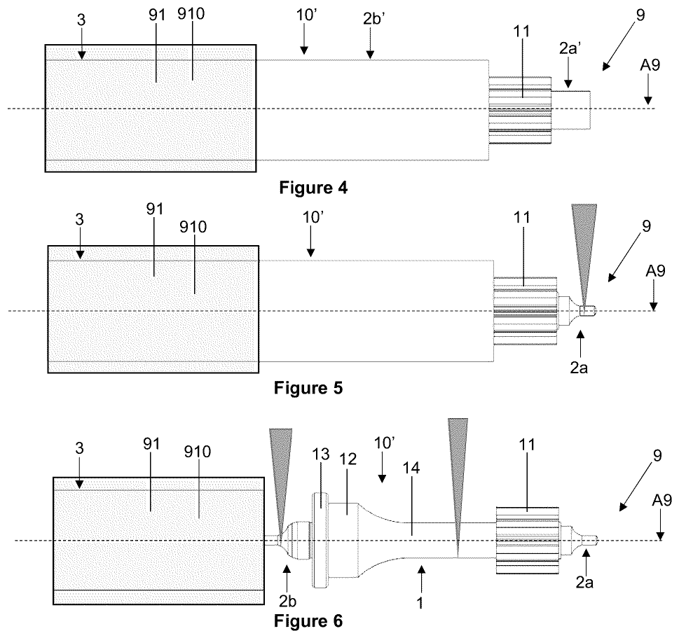

The third portion 2b′ of the blank 10′ has the specific feature of forming a grip part 3 on its end opposite the end with the pinion 11 and the second portion 2a′. The spindle 91, particularly the gripper 910, is thus designed to interact with this grip part 3 of the third portion 2b′ of the blank 10′, to hold it during a single turning phase, as shown in FIG. 4.

As illustrated in FIG. 5, the second laser machining step E2 makes it possible to machine at least a second portion 2a′ of the blank 10′, with a view to transforming it into a second portion 2a of the timepiece component 10, which will be described in greater detail hereinafter. In addition, as illustrated by FIG. 6, this machining also relates to part of the third portion 2b′, so as to form different parts 12, 13, 14 that will also be described in detail hereinafter. Any coaxiality defects between the different portions 1 (positioned between portions 2a and 2b), 2a, and 2b of the timepiece component 10 being manufactured are thus minimized as far as possible.

Preferably, the laser used produces ultrashort pulses. It is particularly a femtosecond laser so that it does not affect the structure of the machined material, in particular during the laser turning, in suitable wavelengths, pulse durations and energy per pulse. In particular, the laser used produces pulses of less than 600 fs, or less than 350 fs. Preferably, the laser beam emits in the infrared with a wavelength of between 800 nm and 1,100 nm, ideally 1,030 nm±5 nm, or in the green with a wavelength of between 500 nm and 540 nm, ideally 515 nm±2.55 nm, or in the blue with a wavelength of between 400 nm and 480 nm, or in the ultraviolet with a wavelength of less than 400 nm, ideally 343 nm±25 nm. In particular, green and UV lasers make it possible to obtain satisfactory roughness values Ra after machining, of the order of 50 nm, or 40 nm, for various technical ceramics.

Preferably, the laser beam has an average energy per pulse of between 0.001 mJ and 2 mJ, preferably between 0.01 mJ and 0.5 mJ, or between 0.04 mJ and 0.05 mJ for the materials and dimensions tested. Also preferably, the laser beam has a diameter of between 5 μm and 100 μm, preferably between 10 μm and 60 μm, and ideally between 15 μm and 25 μm for the materials and dimensions tested.

The side overlap rate, that is, perpendicular to the turning direction, namely perpendicular to the axis A9, is defined by the rotating speed of the blank 10′ and the frequency of the laser, and can be defined between 0% and 99.9%. It is preferably between 20% and 99.9%, ideally between 99.6% and 99.8%.

The longitudinal overlap rate is defined by the scanning speed or turning speed of the beam and the frequency of the laser, and can be defined between 0% and 99.9%. It is preferably between 20% and 99.9%, ideally between 0% and 80.8%.

Thus, at the end of this first machining phase of the second step E2, the surfaces of revolution of the portions 2a and 2b, as well as of the parts 12, 13, 14 of the portion 1 of the timepiece component being manufactured have roughness values Ra of the same order as the functional flanks 111a resulting from the first step, of the order of 50 nm, or of the order of 40 nm. In addition, due to the use of the grip part 3 formed on the blank 10′, all of the machining can be carried out in a single step, in particular in a single turning phase.

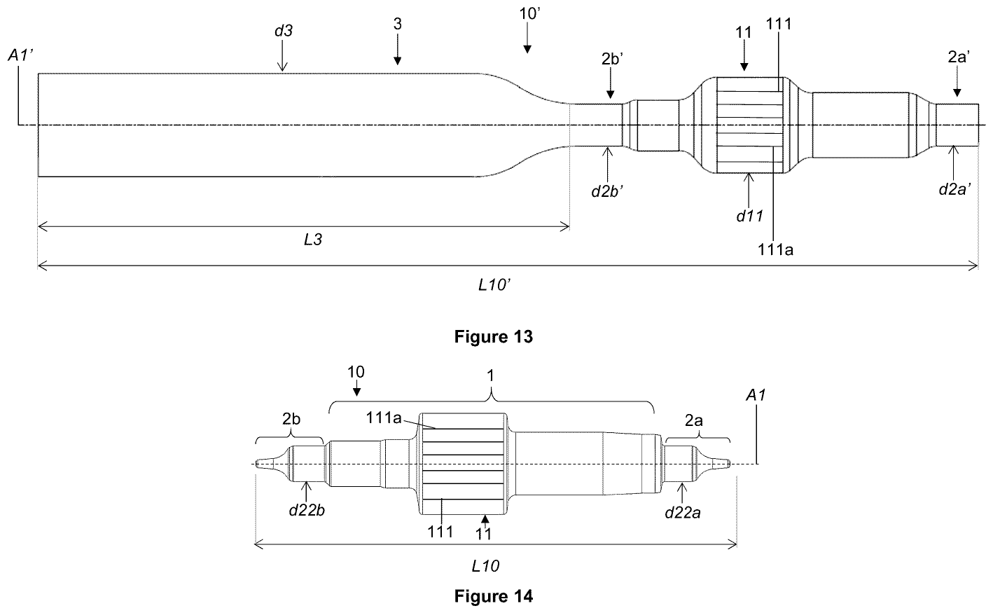

It will be noted that for this advantageous machining as described, the blank 10′ advantageously has a length L10′, measured along the axis A1′ of the blank 10′, greater than the length L10, measured along the axis A1, of the timepiece component 10 being manufactured, as illustrated in particular by FIGS. 13 and 14. This greater length makes it possible to form the grip part 3 described above. Preferably, the grip part 3 has a diameter d3 that corresponds to the greatest diameter of the blank 10′. Preferably, the length L10′ is greater than or equal to 1.5*L10, or greater than or equal to 2*L10. In other words, the length L3 of the grip part is equal or substantially equal to the length L10, or greater than the length L10, in particular of the order of 1.5*L10.

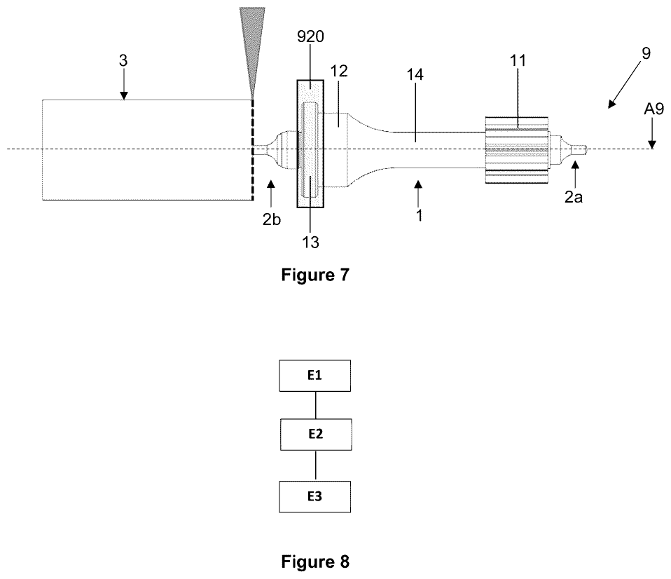

Once the first machining phase described above is finished, a parting-off phase is provided in order to separate the machined portion of the grip part 3 from the third portion 2b′ of the blank 10′, as shown in FIG. 7. Advantageously, this parting-off phase also makes it possible to form the rounded end of the second pivot 21b, the dimensions and/or geometry of which correspond or substantially correspond to those of the finalized second pivot 21b of the timepiece component 10. To this end, a gripper 920 can be provided to interact with, for example, the cylindrical part 13 with the greatest diameter d13 of the previously machined part, in order to hold said part, while the grip part 3 of the blank 10′ is released from the gripper 910. Naturally, any other part of the component is able to interact with the gripper 920.

As a variant, the second machining step could be a mechanical machining step. It could thus comprise a step of turning and/or grinding the blank, and/or rolling the blank, in particular when the component material is an amorphous material, such as a metallic glass.

A timepiece component 10 the geometry and/or dimensions of which correspond or substantially correspond to those of the finalized timepiece component is thus obtained following this second step.

It will therefore be noted that the timepiece component 10 manufactured comprises a first portion with functional flanks that is solely formed by the first micro-injection step and is not modified, or modified very little, by the second machining step. This first step however forms a blank only of at least a second portion of the timepiece component. A second machining step then specifically forms this second portion from this blank, the shape of which is selected to optimize the machining step.

The manufacturing of a timepiece component as described above makes it possible for form a complex component, comprising at least one first portion comprising at least one functional flank, for transmitting energy to another component or dissipating energy from another component, and at least one second portion comprising a guide surface. For their optimum operation, these two portions must have a very precise geometry, and a flawless surface finish with very low roughness. As the surfaces of these two portions have very different shapes and orientations that can be different, it is difficult, or even impossible, to achieve a satisfactory result, in particular satisfactory roughness, simultaneously on these two separate portions by manufacturing them using the same technique, for example a single machining process. Such an approach using a single technique would require long and painstaking tribofinishing, which would not be without risk of ultimately affecting the geometric integrity of one of the two portions so that a satisfactory result was only achieved on the other portion. In particular, the tribofinishing of the first portion could affect the geometric integrity of the guide surface of the second portion, particularly the geometric integrity of the pivot of the second portion.

Using the approach chosen, each portion is ultimately obtained using a different technique, so as to achieve a satisfactory result quickly and simply, which could even render the application of final tribofinishing optional. In addition, as stated, this approach of the invention is also compatible with a large number of materials, including ceramic. The invention has been implemented in a surprising manner with a technical ceramic.

The method according to the invention is thus perfectly suitable for manufacturing a timepiece component integrally formed in one piece that comprises both a functional portion with functional flanks for transmitting torque or more generally energy to another component or for dissipating torque or more generally energy from another component, and a guide portion, comprising a guide surface, in particular a surface of revolution, for guiding the movement of the timepiece component.

The method according to the invention is also perfectly suitable for manufacturing timepiece components with very small dimensions, for example comprising cross-sections inscribed in a circle with a radius less than or equal to 0.2 mm, or less than or equal to 0.1 mm. It also makes it possible to manufacture guide portions, in particular surfaces of revolution, that can have very elaborate geometries on the scale of one tenth of a millimetre, or one hundredth of a millimetre.

It will thus be noted that in very specific scenarios that can be linked to formats and/or particular configurations of the teeth of a pinion, machining, particularly laser machining, could prejudice the mechanical performance of the teeth, and therefore their capacity to transmit torque, due to the energy fluence that passes through the material, particularly ceramic.

It will be noted that, in order to simplify the description, the term “timepiece component” is used to refer to the component obtained after the implementation of the two steps E1, E2 of the method, even though it can undergo one or more additional steps, in particular tribofinishing steps.

Indeed, according to one variant embodiment, the manufacturing method implements an optional third tribofinishing step E3. According to the exemplary embodiment, this third step comprises a phase of bulk polishing the timepiece component 10 resulting from the second step.

Preferably, particularly for a ceramic timepiece component, the tribofinishing step comprises the use of abrasive particles, particularly diamond, the size of which is of the order of 1 μm. Preferably, the tribofinishing step comprises, inter alia, the use of a carrier, particularly ceramic, that can take the form of beads with a dimension of between 125 and 250 μm, to which water and an additive are added. Advantageously, the dimensions and/or geometries of the abrasive particles and/or carriers are configured so that they do not become trapped between the teeth 111 of the pinion 11.

Such bulk polishing makes it possible to obtain a timepiece component comprising a guide surface, particularly ceramic, that is geometrically compliant and has suitable roughness after tribofinishing of a reasonable duration, typically of the order of 10 hours. This tribofinishing step is configured so that it does not modify the geometry of the guide surface, in particular so as to avoid excessively rounding the end of the pivot(s). It is therefore essential that the initial roughness of the first and second portions before this step is low enough to allow a tribofinishing step of a reasonable duration. The roughness Ra of the surface of revolution of the two pivots 21a, 21b ultimately obtained is for example of the order of 10 to 15 nm. More generally, this second step makes it possible to manufacture at least one guide surface with a roughness less than or equal to 15 nm, or less than or equal to 12 nm, or less than or equal to 10 nm, and optionally greater than or equal to 5 nm.

Alternatively or in addition to this third step E3, the second laser machining step E2 can comprise a finishing phase implementing the laser equipment 9, by means of scanning by the laser beam the frequency and/or time of which is configured to polish at least one portion 2a, 2b, preferably the portions 1, 2a, 2b, particularly the pivots 21a, 21b.

In summary, as schematically shown in FIG. 8, the method for manufacturing a timepiece component according to the invention, comprising at least one first portion comprising at least one functional flank for transmitting energy to another component or dissipating energy from another component, and at least one second portion comprising a guide surface, comprises the following steps:
a first micro-injection step E1 forming a blank 10′ of the timepiece component 10, said blank 10′ comprising said at least one first portion and said at least one functional flank and comprising a blank of the second portion, then
a second laser machining step E2, particularly laser machining E2, in particular femtosecond laser machining, of at least part of the blank 10′ of the timepiece component, this part comprising the blank of the second portion for forming the second portion and said guide surface,
optionally, a subsequent third tribofinishing step E3, separate from the second laser machining step E2, in particular a step of bulk polishing and/or polishing using abrasive particles.

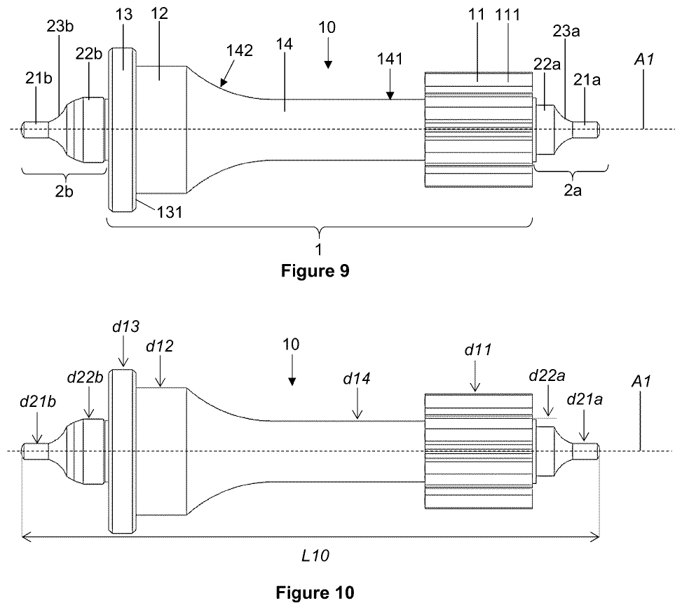

As can be seen from the manufacturing method described above, the invention is particularly suitable for manufacturing complex timepiece components 10, in particular an escape-pinion, as shown in FIGS. 9 to 12.

Such an escape-pinion has an axis A1. It comprises a first portion 1 provided with a pinion 11 provided with teeth 111 the tip-diameter of which is d11.

The flanks 111a of the teeth, oriented radially vis-à-vis the axis A1, here act as functional flanks for transmitting torque with respect to said axis A1. This pinion 11 is formed by the first step of the manufacturing method, as described above.

The first portion 1 of the timepiece component 10 also comprises a first part 12 for receiving another timepiece component, particularly an escape wheel that is intended to be to be driven onto said part 12. Here, the part 12 is more particularly in the form of a right cylinder with a diameter d12. The first portion 1 also comprises a second cylindrical part 13 with a diameter d13, juxtaposed with the first part 12, that is intended to form a surface or seat 131 for receiving such other timepiece component, particularly an escape wheel the plate of which is intended to abut against said surface 131. To this end, the diameter d13 is strictly greater than the diameter d12. As a variant, the timepiece component could be without a cylindrical second part 13, in particular if the plate of the escape wheel is intended to be to be driven into position on the first part 12.

The two parts 12 and 13 are separated from the pinion 11 in a direction parallel to the axis A1 by an intermediate part 14 mainly forming the body of the timepiece component 10. This intermediate part 14 comprises a first section 141 forming a right cylinder with a diameter d14 adjacent to the pinion 11, and a flared second part 142 connecting the first part 12 and the section 141. As a variant, the intermediate part 14 could entirely take the form of a right cylinder.

The escape-pinion also comprises a second portion 2a and a third portion 2b, positioned on either side of the first portion 1. In particular, the second portion 2a is adjacent to the pinion 11 at a first end of the escape-pinion, while the third portion 2b is adjacent to the second part 13 at a second end of the escape-pinion 10. These second and third portions 2a, 2b each respectively comprise a pivot 21a, 21b connected to a pivot-shank 22a, 22b by means of a fillet 23a, 23b. These different parts each form a surface of revolution about the axis A1. In particular, the pivots 21a, 21b each form a surface of revolution about the axis A1. They form guide surfaces for guiding the rotation of the timepiece component about its axis A1. To this end, such an escape-pinion can be considered to comprise two guide surfaces, and thus two second portions.

In the exemplary timepiece component shown, the pivots 21a, 21b each take the form of a right cylinder the tip (namely the end zone) of which is rounded. In particular, these pivots each have the same diameter d21a, d21b that is less than 0.1 mm, of the order of 0.09 mm.

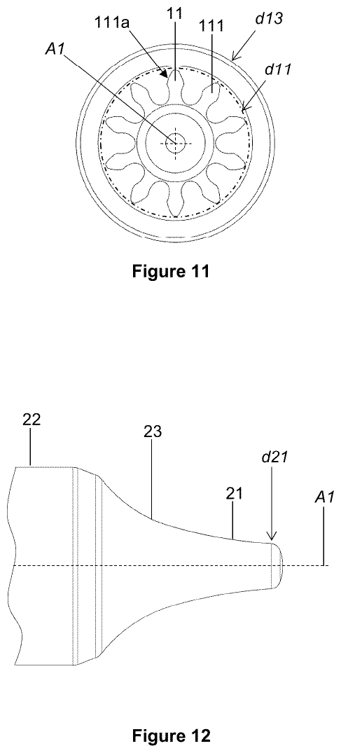

In an alternative pivot design as shown in FIG. 12, the pivot or pivots could form a surface of revolution about an axis comprising a curved generatrix taking the very specific form of a spline or spline curve portions connected continuously. In particular, in this instance, the fillet 23 connecting the pivot 21 to the pivot stem 22 could be formed continuing on from the pivot. In some uses, in particular for a balance staff, one section of a pivot can have a diameter of less than 80 μm, of the order of 50 μm or 60 μm.

The length L10 of the escape-pinion, namely the dimension measured along the axis A1 between the apexes of each of the tips of the pivots 21a, 21b, is preferably greater than 2 mm, or 3 mm, or 4 mm. In the example shown in FIGS. 8 to 11, the length L10 is of the order of 3.2 mm.

The timepiece component has been described in the context of an escape-pinion. Naturally, the invention is not limited to such a timepiece component, which can as a variant be any pinion integral with a shaft, a shaft-mounted yoke, a shaft-mounted lever or a shaft-mounted cam. The timepiece component can be a staff, such as a balance staff of a timepiece oscillator such as a balance wheel-hairspring, in particular a balance staff with notches in order to promote, for example, the retention of the balance wheel and/or the collet of the hairspring, and/or the balance wheel roller. It can be any staff of an escapement train or a staff of a seconds train.

By way of variant embodiment, FIGS. 13 and 14 show the production of a timepiece component 10 that is a balance staff. Preferably, the blank 10′ of this timepiece component 10, shown in FIG. 13, has as close a geometry as possible to that of the final timepiece component 10, shown in FIG. 14, so as to constitute a preform. In particular, in this case of the balance staff blank 10′, the blank particularly comprises a portion 11 with a diameter d11 that corresponds or substantially corresponds to the diameter d11 of the portion 11 of the finalized balance staff. This portion 11 has the specific feature of comprising teeth 111 the flanks 111a of which are designed to allow angular indexing and guarantee the squareness of a balance wheel on the balance staff. The portion 11 thus comprises teeth 111 the flanks 111a of which are designed to dissipate torque or more generally energy from another component of the movement such as a balance wheel (during operation or during assembly) so as to prevent any disconnection of the two components. The flanks 111a thus form angular indexing flanks forming notches between the staff and a balance wheel. In addition, the diameters d2a′ and d2b′ of the cylindrical shapes produced on the blank 10′ at the final ends of the timepiece component 10 are as close as possible to the respective diameters d22a and d22b of the pivot-shanks 22a, 22b of the portions 2a, 2b forming guide surfaces.

Advantageously, the method of the invention is used to manufacture a timepiece component that comprises a guide surface comprising a pivot or taking the form of a pivot. “Pivot” is given to mean a portion of a component, particularly a staff, designed to interact, in particular by contact, with a bearing, particularly a jewel bearing. This pivot can have at least one portion with a cylindrical or conical or frustoconical geometry. The pivot is preferably positioned at one end of the staff. The pivot can, for example, be formed continuing on from a staff portion comprising a surface with a curved generatrix.

The invention also relates to a timepiece movement that also comprises a bearing, or a plurality of bearings mounted on an element of the movement, in particular on a frame of the movement. The timepiece component is thus for example intended to interact, in particular by contact, with the bearing. In particular, the timepiece component interacts with the bearing on the pivot. Even more particularly, the timepiece component interacts with the bearing on a surface of revolution situated on the pivot. The diameter of a cross-section of the surface of revolution is for example less than or equal to 200 μm, or less than or equal to 100 μm, or less than or equal to 80 μm, or less than or equal to 60 μm. Optionally, the pivot can be axially delimited by a cap-stone at one end of the pivot.

Advantageously, the timepiece component comprises two pivots for interacting with two bearings so as to guide the timepiece component with respect to the bearings and more generally with respect to the timepiece movement element on which the bearings are mounted.

Advantageously, the timepiece component or part of the timepiece component is made from ceramic, in particular entirely made from ceramic.

The surface of revolution forming the guide surface is thus made from ceramic, that is, the surface of revolution is formed or located on a ceramic part of the component. Preferably, the ceramic is a zirconia, particularly an yttria-stabilized zirconia, in particular a 3% yttria-stabilized zirconia (namely comprising an yttria content of 3 mol %), a monocrystalline alumina or an alumina-zirconia combination (ATZ). The timepiece component as a whole, or at least a part comprising a first portion with at least one functional flank and a second portion comprising a guide surface, is advantageously integrally formed in one piece.

Preferably, all or part of the timepiece component is thus made from ceramic, and comprises a guide surface the roughness Ra of which is less than or equal to 15 nm. Also preferably, the timepiece component comprises a pivot comprising said guide surface. Advantageously, the shear failure stress of the pivot of the component is greater than 200 N·mm², or greater than 250 N·mm².

1. A method for manufacturing a timepiece component comprising at least one first portion comprising at least one functional flank, for transmitting energy to another component or dissipating energy from another component, and at least one second portion comprising a guide surface, the method comprising:
carrying out a first micro-injection forming a blank of the timepiece component, the blank comprising the at least one first portion and the at least one functional flank and comprising a blank of the second portion, then
carrying out a second machining of at least one part of the blank of the timepiece component, the at least one part of the blank of the timepiece comprising the blank of the second portion for forming the second portion comprising the guide surface,
the second machining being implemented excluding the at least one first portion, which remains unchanged during the second machining.

2. The method according to claim 1, further comprising a subsequent third tribofinishing, separate from the machining.

3. The method according to claim 2, wherein the third tribofinishing step has a duration less than or equal to 15 hours, so as to obtain a roughness Ra of the guide surface of less than 15 nm.

4. The method according to claim 1, wherein the first micro-injection comprises injecting a material into an injection cavity of an injection mould, the material being a polymer, a composite, a metal or a technical ceramic.

5. The method according to claim 4, wherein the injection mould comprises an injection cavity at least partially made from a material comprising nickel Ni or nickel phosphorous NiP, the injection cavity comprising a cut-out adapted to form the at least one functional flank of the first portion and/or to form the blank of the second portion.

6. The method according to claim 4,
wherein the injection cavity of the injection mould comprises a shape that makes it possible to simultaneously manufacture a plurality of blanks for a timepiece component, rigidly connected to each other by an intermediate support, and in that
wherein the method comprises separating the plurality of blanks from the intermediate support after removal from the mould.

7. The method according to claim 1, wherein the second machining comprises a second laser machining comprising a phase of turning about an axis of rotation corresponding to an axis of the blank, during which a laser beam is moved with respect to the axis of rotation.

8. The method according to claim 1, wherein the second machining comprises a second laser machining, the laser of the second machining being a laser emitting an infrared laser beam, or a green laser beam, or an ultraviolet laser beam, or a blue laser beam.

9. The method according to claim 1, wherein the first micro-injection produces the at least one functional flank having a surface roughness Ra less than or equal to 50 nm.

10. The method according to claim 1, wherein the second machining comprises a second laser machining, the laser of the second machining producing a guide surface having a roughness Ra less than or equal to 50 nm.

11. The method according to claim 1,
wherein the second machining comprises gripping the blank for a timepiece component using a grip part, arranged at one end of the blank for a timepiece component, a length of the grip part being greater than a length of the timepiece component to be manufactured, in order to hold the blank for a timepiece component during machining, and
wherein the second machining comprises a final parting-off of the grip part in order to remove the grip part and obtain the blank for a timepiece component having a length equal or substantially equal to the length of the timepiece component to be manufactured.

12. The method according to claim 1, wherein the timepiece component is a pinion integral with a shaft, or a shaft-mounted lever, or a shaft-mounted cam, or a balance staff provided with a notching.

13. The method according to claim 1, wherein the functional flank of the first portion is configured to transmit movement or torque.

14. The method according to claim 1, wherein the guide surface of the second portion comprises a surface of a pivot of the timepiece component and/or at least one section having a diameter less than or equal to 200 μm.

15. A timepiece component comprising:
at least one first portion comprising at least one functional flank, for transmitting energy to another component or dissipating energy from another component, and
at least one second portion comprising a guide surface,
wherein the first and second portions of the timepiece component are integrally formed in one piece and
wherein the functional flank has a surface roughness Ra less than or equal to 50 nm.

16. The timepiece component according to claim 15, wherein the first and second portions are made from a polymer, a composite, a metal or a technical ceramic.

17. The timepiece component according to claim 15, wherein the guide surface comprises a pivot forming a surface of revolution and comprising at least one section having a diameter less than or equal to 200 μm, and a roughness Ra less than 15 nm.

18. The timepiece component according to claim 15, which is a pinion integral with a shaft, or a shaft-mounted yoke, or a shaft-mounted lever, or a shaft-mounted cam, or a balance staff provided with detents.

19. The method according to claim 2, wherein the third tribofinishing comprises a bluk polishing and/or implements abrasive particles and/or implements abrasive carriers.

20. The method according to claim 1, wherein the second machining comprises a laser machining and a finishing carrying out polishing using the same laser, reconfigured, as used for the laser machining.
